(19) United States
(12) Patent Application Publication
(10) Pub. No.: US 2012/0269926 A1
(43) Pub. Date: Oct. 25, 2012

(54) YEAST EXTRACT AND METHOD OF PRODUCNG THE SAME

(76) Inventors: Xuefeng YU, Yichang (CN); Zhihong LI, Yichang (CN); Minghua YU, Yichang (CN); Juan YAO, Yichang (CN); Pei LI, Yichang (CN); Ku LI, Yichang (CN); Guanqun TANG, Yichang (CN)

(21) Appl. No.: 13/540,600

(22) Filed: Jul. 2, 2012

Related U.S. Application Data
(63) Continuation-in-part of application No. 12/854,194, filed on Aug. 11, 2010.
Application No. 12/854,194 is a continuation of application No. PCT/CN2008/072153, filed on Aug. 26, 2008.

(30) Foreign Application Priority Data
Feb. 19, 2008 (CN) 200810007940.8

(51) Int. Cl. A23L 1/28

(52) U.S. Cl. 426/60; 426/655; 426/62

(57) ABSTRACT

A method for producing yeast extract including 4-30% disodium inosinate and disodium guanylate (I+G), comprising a) providing a yeast cream including 8 wt. % or more of RNA, b) inactivating the yeast in the yeast cream, c) centrifugating the yeast cream and collecting a supernatant, d) degrading the supernatant with enzymes, e) heat-treating, and f) concentrating and drying the supernatant. The resultant yeast extract is natural, involves no additive, and has better flavor. The invention further provides yeast extract is produced by the method.

### CROSS-REFERENCE TO RELATED APPLICATIONS

This application is a continuation-in-part of U.S. patent application Ser. 12/854,194, filed Aug. 11, 2010, which is a continuation of International Patent Application No. PCT/CN2008/072153 with an international filing date of Aug. 26, 2008, designating the United States, now pending, and further claims priority benefits to Chinese Patent Application No. 200810007940.8 filed Feb. 19, 2008. The contents of all of the aforementioned applications, including any intervening amendments thereto, are incorporated herein by reference.

### BACKGROUND OF THE INVENTION

1. Field of the Invention

The invention relates to a method for producing yeast extract comprising between 4 and 30 wt. % of disodium inosinate and disodium guanylate (I+G, wherein I represents disodium inosinate and G represents disodium guanylate), and to yeast extract comprising disodium inosinate and disodium guanylate produced by the method.

2. Description of the Related Art

Yeast extracts are soluble and nutritious condensate extracted from yeasts, and can be directly absorbed by human body. The latest generation of yeast extracts is rich in glutamic acid and nucleotides and exhibits more delicious flavor, and mixed with amino acids and peptides extracted from the yeasts, the sodium salt content is decreased greatly but the flavor has not been affected. More importantly, the yeast extract is a natural product, involving no artificial compounds and chemical additives.

Disodium 5′-ribonucleotide is a nucleotide flavor enhancer and prepared by mixing disodium inosinate (IMP) and disodium guanylate (GMP) with a weight ratio of 1:1. The product can be directly added to food to enhance flavor. It is economic and highly effective, widely applied to instant noodle seasoning packet, chicken essence seasoning, and soy sauce.

Zhong Ruimin et al. disclose a method for producing yeast extract with ultra low salt content ,light color, and meaty flavor (Zhong Ruimin, Huang Guoqing, Liu Jiannan, 2004 (2), Chinese Condiment, Dept. of Food Technology; Yingdong School of Biotechnology; Shaoguan University). Fresh beer yeasts are washed to remove bitterness at low temperature and the cell wall thereof is broken to some extent by slow freezing and then thawing. 5% ethanol is added, the cell wall is broken with ultrasonic wave, and 46.3 wt % of nitrogenous compounds flow out of the cells. The glucose content of yeasts is 1.49 wt. % (based on fresh yeast) before autolysis, which can brown and darken the color of the yeast solution after autolysis. The color can be protected by active dry yeast fermentation and removing glucose with glucose oxidase. Thus, a light yellow autolysis solution is obtained. The treatment before fermentation has an obvious influence on the flavor of the yeast extract. The extract has chicken flavor, with nitrogen content (in manner of amino acids) exceeding 5.12 wt. % (based on dry yeast). The method produces yeast extract with ultra low salt content, light color, and meaty flavor.

A method for producing flavor nucleotides I+G by enzymatic degradation of nucleic acid is disclosed (Sugarcane and Canesugar, 2000 (3)). As a raw material, RNA is degradated with enzyme twice, separated, refined, dried, and ground to yield a composite flavor enhancer including 50% of 5′-IMP.Na₂.7H₂O (I) and 50% of 5′-GMP.Na₂.7H₂O (G).

Chinese Patent Application No. 200510124942.1 discloses yeast extract including high content of 5′-ribose nucleotide and amino acids. A food yeast is dissolved with an acid solution and separated with a centrifuge. The precipitate is washed with water and mixed with an enzyme originated from an actinomycetes. The yeast extract includes at least 24 wt. % of 5′-inosine and 5′-guanosine, a peptide 20. wt % or more, and the peptide and free amino acid 28 wt. % or more.

Conventional yeast extracts include a large amount of proteins and amino acids, with mellow taste, but have less disodium 5′-ribonucleotide, thereby resulting in insufficient flavor. Pure disodium 5′-ribonucleotide is expensive, and if used alone, the taste is not mellow and the flavor is not enough. To mix disodium 5′-ribonucleotide with amino acids can produce good flavor. The mixing means 5′-ribonucleotide is added as an additive. Thus, the product must be labeled to include an additive, and thereby it is not natural.

Thus, it is urgent to produce a natural yeast extract including high content of disodium 5′-ribonucleotide and without additives.

### SUMMARY OF THE INVENTION

In view of the above-described problems, it is one objective of the invention to provide a method for producing yeast extract comprising high content of natural disodium nucleotide and without additives.

It is another objective of the invention to provide yeast extract comprising high content of natural disodium nucleotide and without additives.

To achieve the above objectives, in accordance with one embodiment of the invention, there is provided a method for producing yeast extract comprising high content of natural disodium nucleotide, the method comprising the steps of
a) preparing a yeast cream from a yeast comprising 8 wt. % or more of RNA, the yeast being a bread yeast, a fermented beer yeast, a torula, or a mixture thereof;
b) inactivating the yeast in the yeast cream under a temperature of between 40 and 95° C.;
c) centrifugating the yeast cream and collecting a supernatant;
d) adding a protease, a nuclease, and a deaminase simultaneously to the supernatant and allowing to react for 12-25 hrs at 35-80° C. with a pH value of 4.0-6.8;
e) treating the supernatant at a temperature of 75-90° C. for 50-70 min so as to inactivate the enzymes; and
f) concentrating the supernatant to comprise 35-40 wt. % of a dry matter and spray drying the dry matter to yield yeast extract comprising 4-30 wt. % of disodium inosinate and disodium guanylate.

In a class of this embodiment, a weight ratio of the protease to the nuclease to the deaminase is 1:1:1.

In a class of this embodiment, the total addition amount of the protease, the nuclease, and the deaminase added in d) is 0.1-0.3 wt. % of the dry matter in the supernatant.

In a class of this embodiment, the temperature in step d is between 45 and 68° C.

In a class of this embodiment, the temperature in d) is between 45 and 55° C.

In a class of this embodiment, the pH value in step d is between 4.5 and 6.8.

In a class of this embodiment, the reaction time in step d is between 16 and 20 hrs.

In accordance with another embodiment of the invention, there is provided yeast extract comprising high content of natural disodium nucleotide, the yeast extract being produced by the above-mentioned method.

In a class of this embodiment, the yeast extract comprises between 4 and 30 wt. % of disodium inosinate and disodium guanylate.

In a class of this embodiment, the yeast extract comprises between 10 and 30 wt. % of disodium inosinate and disodium guanylate.

In a class of this embodiment, the yeast extract comprises between 14 and 29 wt. % of disodium inosinate and disodium guanylate.

The yeast extract of the invention has more delicious taste and can improve the food flavor. Because no international standards evaluate a food taste at present, FIG. 2 provides a reference, which shows the durability of taste intensity of the yeast extract of the invention is better. Although directly adding nucleotides to a common yeast extract improves the flavor, the food involves additives and is not natural.

### BRIEF DESCRIPTION OF THE DRAWINGS

The invention is described hereinbelow with reference to accompanying drawings, in which:

FIG. 1 is a flow chart of a method of producing yeast extract comprising high content of natural disodium nucleotide according to one embodiment of the invention; and

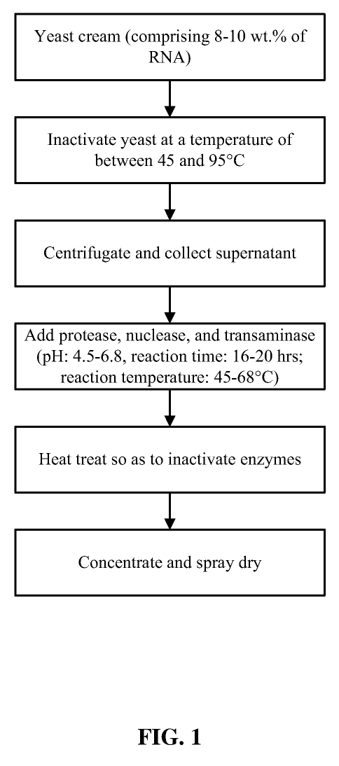

FIG. 2 is a curve diagram of different foods between taste intensity and time.

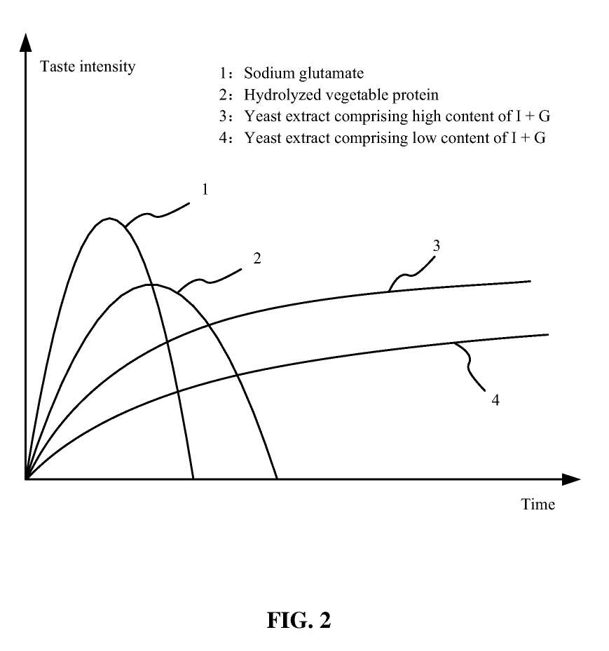

### DETAILED DESCRIPTION OF THE EMBODIMENTS

For further illustrating the invention, experiments detailing a method of producing yeast extract comprising high content of natural disodium nucleotide are described below. It should be noted that the following examples are intended to describe and not to limit the invention.

a) A bread yeast comprising 8 wt. % or more of RNA is cultured with molasses as culture medium. Optionally, a fermented beer yeast or a torula can be used. All these yeast should comprises 8 wt. % or more of RNA. The yeast is prepared into a yeast cream.

b) The yeast is inactivated in the yeast cream under a temperature of between 40 and 95° C.

c) The yeast cream is centrifugated and the supernatant is collected.

d) A protease, a nuclease, and a deaminase with a weight ratio of 1:1:1 are added to the supernatant simultaneously and allowed to react for 12-25 hrs at 35-80° C. with a pH value of 4.0-6.8; the total addition amount of the protease, the nuclease, and the deaminase added in d) is 0.1-0.3 wt. % of the dry matter in the supernatant.

e) The supernatant is heated to a temperature of 75-90° C. so as to inactivate the enzymes.

f) The supernatant is concentrated and the resultant dry matter is spray dried to yield yeast extract comprising 4-30 wt. % of disodium inosinate and disodium guanylate.

Preferably, in step d, the temperature is between 45 and 68° C.

More preferably, in step d, the temperature is between 45 and 55° C.

In the step f), the supernatant is concentrated to comprise 30 wt. % of the dry matter.

### EXAMPLE 1

A bread yeast comprising 8 wt. % or more of RNA is prepared into a yeast cream. The yeast in the yeast cream is inactivated under 50° C. The yeast cream is centrifugated and the supernatant is collected. A protease, a nuclease, and a deaminase with a weight ratio of 1:1:1 are added simultaneously to the supernatant and allowed to react for 16 hrs at 45° C. with a pH value of 5.2. The total addition amount of the protease, the nuclease, and the deaminase is 0.2 wt. % of the dry matter in the supernatant. The supernatant is maintained at 85° C. for 30 min so as to inactivate the enzymes. Subsequently, the supernatant is concentrated and the resultant dry matter is spray dried to yield yeast extract comprising 18 wt. % of disodium inosinate and disodium guanylate, among which disodium inosinate is 10 wt. % and disodium guanylate is 8 wt. %. The content is determined by HPLC. One objective of the invention is to produce a product comprising a mixture of I and G. Thus, in the final product of the invention, the I and G are not separated.

The yeast extract comprising high content of I and G has more delicious taste and better capability to enhance the food flavor.

### EXAMPLE 2-10

Based on the steps of Example 1, to modify some process conditions and material amounts as Tables 1 and 2, the invention is carried out and the resultant yeast extracts have the same properties as those in Example 1.

TABLE 1

| | | | | Ex- | | Ex- |
|---|---|---|---|---|---|---|
| | | Exam- | Exam- | am- | Exam- | am- |
| | | ple 2 | ple 3 | ple 4 | ple 5 | ple 6 |
| RNA content of yeast (%) | | 8 | 8 | 9 | 9 | 10 |
| Temperature of inactivating | | 40 | 45 | 50 | 55 | 60 |
| yeast (° C.) | | | | | | |
| Yeast cream pH | | 4.5 | 4.9 | 5.4 | 5.9 | 6.4 |
| Temperature of enzyme | | 35 | 45 | 55 | 65 | 75 |
| treatment (° C.) | | | | | | |
| Heat | Temperature (° C.) | 85 | 85 | 85 | 85 | 85 |
| treating | Time (min) | 30 | 30 | 30 | 30 | 30 |
| | pH | 6.5 | 6.5 | 6.5 | 6.5 | 6.5 |

| | | | | | |
|---|---|---|---|---|---|
| Total amount of I + G (%) | 7.4 | 10 | 12 | 14 | 17 |

TABLE 2

| | | | | | Example |
|---|---|---|---|---|---|
| | | Example 7 | Example 8 | Example 9 | 10 |
| RNA content of | | 10 | 10 | 11 | 12 |
| yeast (%) | | | | | |
| Temperature of | | 65 | 70 | 75 | 80 |
| inactivating yeast (° C.) | | | | | |
| Yeast cream pH | | 6.8 | 4.5 | 4.9 | 5.4 |
| Temperature of enzyme | | 80 | 35 | 45 | 55 |
| treatment (° C.) | | | | | |
| Heat | Temperature | 85 | 85 | 85 | 85 |
| treating | (° C.) | | | | |
| | Time (min) | 30 | 30 | 30 | 30 |
| | pH | 6.5 | 6.5 | 6.5 | 6.5 |

| | | | | |
|---|---|---|---|---|
| Total amount of I + G | 20 | 23 | 26 | 29 |
| (%) | | | | |

The tables show that the method of the invention can produce yeast extract comprising 4-30 wt. % of I+G

### COMPARISON EXAMPLE

Chinese Patent Application No. 200510124942 discloses yeast extract comprising high content of 5′-ribose nucleotide and a method for producing the same.

In the method, a food yeast is treated with an acid solution and centrifugated. The precipitate is washed with water and then an enzyme originated from an actinomycetes is added. The final product is yeast extract comprising high content of 5′-ribose nucleotide, among which the total amount of 5′-inosine and 5′-guanosine is 24 wt. % or more, a peptide 20. wt % or more, and the total amount of peptide and free amino acid 28 wt. % or more.

In the comparison example, the total amount of I and G is high, while that of the peptide and free amino acid is low.

In the present invention, the total amount of peptide and free amino acid exceeds 35 wt. %, and that of I and G can be higher, which provides more delicious taste. The comparison is shown in Table 3.

TABLE 3

| | | | Comparison |
|---|---|---|---|
| | Example 8 | Example 9 | example |
| The total amount of peptide | 35% | 38% | 28% |
| and free amino acid | | | |

In the invention, the weight ratio of the peptide to the free amino acids is between 2:3 and 1:1. The peptide amount is determined by HPLC. The amino acid amount is determined using an amino acid analyzer.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for producing yeast extract comprising disodium inosinate and disodium guanylate, the method comprising the steps of:
a) preparing a yeast cream from yeast comprising 8 wt. % or more of RNA based on the weight of said yeast cream, said yeast being a bread yeast, a fermented beer yeast, a torula, or a mixture thereof;
b) inactivating said yeast in said yeast cream under a temperature of between 40 and 95° C.;
c) centrifugating said yeast cream and collecting a supernatant;
d) adding a protease, a nuclease, and a deaminase simultaneously to said supernatant and allowing to react for between 12 and 25 hrs at a temperature of between 45 and 68° C. with a pH value of between 4.0 and 6.8;
e) treating said supernatant at a temperature of between 75 and 90° C. for between 50 and 70 min so as to inactivate the enzymes; and
f) concentrating said supernatant to comprise between 35 and 40 wt. % of a dry matter based on the weight of said supernatant and spray drying said dry matter to yield yeast extract comprising between 4 and 30 wt. % of disodium inosinate and disodium guanylate based on the weight of said yeast extract.

2. The method of claim 1, wherein a weight ratio of said protease to said nuclease to said deaminase is 1:1:1.

3. The method of claim 1, wherein the total amount of said protease, said nuclease, and said deaminase added in d) is critically between 0.1 and 0.3 wt. % of the dry matter in said supernatant obtained in c).

4. The method of claim 1, wherein the pH value in d) is between 4.5 and 6.8.

5. The method of claim 1, wherein the temperature in d) is between 45 and 55° C.

6. The method of claim 1, wherein the reaction time in d) is between 16 and 20 hrs.

7. Yeast extract comprising between 4 and 30 wt. % of disodium inosinate and disodium guanylate produced by the method of claim 1, wherein said yeast extract further comprises a peptide and a free amino acid, and the combined amount of the peptide and free amino acid exceeds 35 wt. % based on the weight of said yeast extract.

8. The yeast extract of claim 7, wherein said yeast extract comprises between 10 and 30 wt. % of disodium inosinate and disodium guanylate.

9. The yeast extract of claim 8, wherein said yeast extract comprises between 14 and 29 wt. % of disodium inosinate and disodium guanylate.

10. The yeast extract of claim 7, wherein a weight ratio of said protease to said nuclease to said deaminase is 1:1:1.

11. The yeast extract of claim 7, wherein the total amount of said protease, said nuclease, and said deaminase added in d) is critically between 0.1 and 0.3 wt. % of the dry matter in said supernatant obtained in c).

12. The yeast extract of claim 7, wherein the pH value in d) is between 4.5 and 6.8.

13. The yeast extract of claim 7, wherein the reaction time in d) is between 16 and 20 hrs.

14. A method for producing yeast extract comprising disodium inosinate and disodium guanylate, the method comprising:
a) preparing a yeast cream from yeast comprising 8 wt. % or more of RNA based on the weight of said yeast cream, said yeast being a bread yeast, a fermented beer yeast, a torula, or a mixture thereof;
b) inactivating said yeast in said yeast cream under a temperature of between 40 and 95° C.;
c) centrifugating said yeast cream and collecting a supernatant;
d) adding a protease, a nuclease, and a deaminase simultaneously to said supernatant and allowing to react for between 12 and 25 hrs at between 45 and 68° C. with a pH value of between 4.0 and 6.8; the total amount of said protease, said nuclease, and said deaminase is critically between 0.1 and 0.3 wt. % of the dry matter in said supernatant obtained in c);
e) treating said supernatant at a temperature of between 75 and 90° C. for between 50 and 70 min so as to inactivate the enzymes; and
f) concentrating said supernatant to comprise between 35 and 40 wt. % of a dry matter based on the weight of said supernatant and spray drying said dry matter to yield yeast extract comprising between 4 and 30 wt. % of disodium inosinate and disodium guanylate based on the weight of said yeast extract.

15. The method of claim 14, wherein a weight ratio of said protease to said nuclease to said deaminase is 1:1:1.

16. The method of claim 14, wherein the pH value in d) is between 4.5 and 6.8.

17. The method of claim 14, wherein the temperature in d) is between 45 and 55° C.

18. Yeast extract comprising between 4 and 30 wt. % of disodium inosinate and disodium guanylate produced by the method of claim 14, wherein said yeast extract further comprises a peptide and a free amino acid, and the combined amount of the peptide and free amino acid exceeds 35 wt. % based on the weight of said yeast extract.

19. The yeast extract of claim 18, wherein said yeast extract comprises between 10 and 30 wt. % of disodium inosinate and disodium guanylate.

20. The yeast extract of claim 19, wherein said yeast extract comprises between 14 and 29 wt. % of disodium inosinate and disodium guanylate.
